(19) United States
(12) Patent Application Publication
(10) Pub. No.: US 2016/0297509 A1
(43) Pub. Date: Oct. 13, 2016

(54) SANDWICH PANEL FOR AN AIRCRAFT

(71) Applicant: Airbus Operations GmbH, Hamburg (DE)

(72) Inventors: Jean-Bernard Estadieu, Hamburg (DE); Lubka Tchankova, Hamburg (DE); Fedor Dering, Hamburg (DE)

(73) Assignee: Airbus Operations GmbH, Hamburg (DE)

(21) Appl. No.: 15/041,474

(22) Filed: Feb. 11, 2016

(30) Foreign Application Priority Data
Apr. 13, 2015 (DE) 10 2015 105 603.8

(51) Int. Cl. B64C 1/18; B29C 67/00

(52) U.S. Cl. CPC B64C 1/18; B29C 67/0055; B29K 2071/00

(57) ABSTRACT

A sandwich panel for an aircraft includes a lower top layer, an upper top layer and a core layer, wherein the core layer in turn includes pins. The pins extend from a lower top layer in the direction of the upper top layer, and the pins are interconnected by rods. In addition, the rods run inside the core layer, and the pins and rods form a one-piece network.

### FIELD OF INVENTION

The invention relates to sandwich panels for aircraft, in particular a sandwich panel with pins, rods and honeycombs fabricated in a printing process, a method for manufacturing a sandwich panel for an aircraft, as well as an aircraft with a sandwich panel.

### BACKGROUND OF THE INVENTION

Sandwich panels for aircraft are often fabricated as a laminate structure, also referred to as a sandwich structure. Current sandwich panels consist of a respective lower and upper top layer and a core. The core serves to separate the top layers from each other, i.e., assumes the role of a spacer between the top layers. As a result, the sandwich panel can efficiently absorb tensile and compressive forces in the top layers. The tensile and compressive forces in the top layers stem primarily from bending stress, meaning from a load that acts perpendicularly on one of the top layers of the sandwich panel. The core layer of the sandwich component is usually fabricated to resemble a honeycomb. Such honeycomb panels, referred to as honeycombs for short, are suitable as lightweight components for airplane construction due to the almost completely automated production process. The honeycombs themselves are made out of paper-like materials, and are usually saturated and cured with an adhesive matrix, for example phenol resin. The top layers can be made out of fiber composite materials, for example with carbon fibers, or also glass fibers in epoxy or phenol resin.

In addition to the honeycombs in the core layer, elements with a higher strength are inserted into the core layer, and used for the flow of shear stresses between the panels and connected airplane structures. Such “plugs” or “inserts” can be joined with the top layers through adhesive bonding, for example.

### SUMMARY OF THE INVENTION

A first aspect of the invention relates to a sandwich panel for an aircraft, for example a floor panel, exhibiting a lower top layer, an upper top layer and a core layer, wherein the core layer exhibits pins, wherein the pins extend from the lower top layer in the direction of the upper top layer, wherein the pins are interconnected by rods, wherein the rods run inside the core layer, and wherein the pins and rods form a one-piece network.

Such a sandwich panel can also generally be referred to as a sandwich component, since it exhibits the typical features of the latter, namely a respective top layer on the upper side and lower side of the component, wherein the two top layers are separated from each other by a core layer. For example, the top layers can be made out of fiber composite structures. Carbon fibers can be embedded in phenol resin or epoxy resin, but glass fibers or aramid fibers can also be used. Therefore, a top layer can be fabricated out of one or several material combinations, so as to utilize the various advantageous properties. For example, the high tensile strength of carbon fibers can be combined with the relatively high pressure stability of glass fibers in two different layers. Aramid fibers could also be used for the edge layers in light of their especially high impact strength. The core layer exhibits pins that space the top layers apart. The pins extend from one top layer to another, meaning that they essentially run at a right angle to the top layers. For example, the pins are columnar structures without any buckling or bending. The pins can be exposed primarily to compressed air, but can also absorb shear stress. The pins are interconnected by rods. While the pins denote the columnar structures between the top layers, the rods represent the transverse connections between the pins. In other words, the rods are usually not directly connected with the top layers, with the rods instead interconnecting the pins. The rods run inside the core layer, meaning that they do not penetrate through the top layers. However, it can also be that the rods do not contact the core layer. Therefore, the core layer can exhibit these pins and rods, and otherwise be filled with air, i.e., be essentially hollow. For example, the pins can be joined with the top layers via adhesive bonding, or with a resin that cures after or even during assembly.

The pins and rods form a one-piece network. In other words, both are made out of a continuous material, and are continuously joined together. An adhesive bond or some other type of connection that might have to be utilized in an assembly process is not required. Pins and rods form a single component. The separation into pins and rods arises purely from the function and arrangement of the pin and rod elements. Both the pins and rods are not only fabricated out of a shared raw material, but thus also in a single manufacturing step. In other words, pins and rods are fabricated together without a seam. Rather, these are derived from one material and one production apparatus in a single process.

In one potentially advantageous effect of the invention, a coordinated and planned manufacture of a single element comprised of pins and rods makes it possible to generate a structure that satisfies the load cases. In other words, the component geometries are taken into account in a production process suitable for that purpose. Therefore, there exists an advantageous dependence between the production process and product shape.

In an embodiment of the invention, the pins and rods are fabricated in an additive manufacturing process (“additive manufacturing” process).

A suitable manufacturing process for delicate, complicated and special, i.e., locally varying, component geometries is referred to as “additive manufacturing”, and colloquially also as “3D printing”. In this method, materials, usually plastics, are applied in layers until such time as the sum of layers completes the component. The layered application of the plastic makes it possible to generate predefined geometries, for example via computer-aided design, wherein a variable geometry means only a little or no additional outlay by comparison to repeating patterns in the structure. As opposed to mass-produced honeycomb layers, which are manufactured in folding and adhesive bonding processes, additive manufacturing permits a deviation without modifying the production process. For example, the structure of the network of pins and rods is generated in a CAD program (computer-aided design). This structure can then be directly sent to the 3D printer, which builds up the structure layer by layer. As a consequence, the pins and rods can be fabricated in a single production process, by a single manufacturing apparatus, and out of one and the same material. For example, the apparatus for the additive manufacturing process, i.e., the 3D printer, exhibits a piezo-ceramic die, which can be opened and closed at a high frequency, and out of which a plastic raw material flows. The plastic raw material then cures during or after the printing process. For example, the plastic raw material still contains short fibers comprised of carbon fiber material or glass fibers. It can also contain additional particles, such as ceramic particles, for example.

In another embodiment of the invention, the rods adjoin the pins at a right angle in the middle of the longitudinal direction of the pins.

In this embodiment, the rods adjoin the pins in the middle of the pins, i.e., at half the height of the pins. In other words, the rods run parallel to the top layers, and along an imaginary central plane between the top layers. This can also mean that the rods are arranged in a symmetry plane of the sandwich component. The right angle relates to the angle between the rods and pins, the opposite angle to which defines the inclination of the rods relative to the cover plates, provided the pins run at a right angle to the top layers.

In another embodiment of the invention, the core layer further exhibits honeycombs, wherein the honeycombs are arranged in such a way that a first opening of a honeycomb extends to the lower top layer, and a second opening of the honeycomb extends to the upper top layer, and the lateral walls of the honeycombs extend at a right angle to the lower top layer and to the upper top layer. Such honeycombs can span a larger volume than those honeycombs usually employed in prior art. The reason is that the pins and honeycombs are side by side, and simultaneously function to space apart the two top layers. However, the honeycombs are able to introduce additional shear stiffness into the sandwich panel, and diminish the danger that the pins will buckle when exposed to a pressure load.

In another embodiment of the invention, a plurality of pins and rods is situated in the space spanned by a honeycomb, wherein the honeycomb, pins and rods are made out of a continuous material, so that the rods in conjunction with the pins and honeycombs are designed as a single piece.

In this embodiment, a plurality of pins is located inside of a honeycomb. Depending on the diameter of the pins and density of the pins on a surface unit of the top layers, several to very many pins can be incorporated inside of a honeycomb. For example, if the pins are very delicate and the honeycomb spaces are correspondingly large, a number of pins per honeycomb unit can measure on the order of 101 or even 102. The pins, the rods and also the honeycombs can be fabricated in one and the same process of additive manufacturing, i.e., via 3D printing. As a result, the network of pins and rods can form a single unit by connecting the rods to the honeycombs. For example, the material of the rods can smoothly transition into the material of the honeycombs, e.g., if the die of the printer traverses the plane of the rods in a continuous motion to a point where the honeycomb border becomes part of the rod printing process, at least in this plane. In other words, a print job generates a single component consisting of pins, rods and honeycombs.

In another embodiment of the invention, the honeycombs consist of polyether ether ketone and/or the lower top layer and the upper top layer consist of carbon fiber-reinforced plastic.

For example, the polyether ether ketone plastic can contain short fibers with a length of 0.1 mm to 1 mm, which then can be applied together with the polyether ether ketone in the printing process. A carbon fiber-reinforced plastic is an example for the material top layers.

Another embodiment of the invention indicates a sandwich panel, wherein a first group of pins exhibits a different diameter than a second group of pins.

If corresponding knowhow is on hand about load introductions, load distributions or other stress-determining boundary conditions, the pins and rods can be correspondingly adjusted to the arising load. For example, a higher diameter for the pins diminishes the buckling of pins, meaning the instability of the pins as a result of being exposed to an excessively high pressure load. In particular when using the “additive manufacturing” production process, the pins can be fabricated in individual diameters, without this giving rise to a significantly higher outlay in the manufacturing process itself.

In another embodiment of the invention, the core layer exhibits an insert, and the diameter of the pins increases toward the insert.

The insert can be a so-called “insert”, also referred to as “plug”. Such an insert is often incorporated in the core layer to allow stress to flow between the panels and connected airplane structures. The insert most often requires a recess in the respective structure of the core layer, into which the insert can be incorporated. However, each recess in a loaded structure can mean stress peaks in the structure around the recess. A notch effect can emanate even from very small recesses. In this regard, it is best in terms of structural strength to reinforce the elements or material around the recess, i.e., around the insert. As described in this embodiment, the pins can be provided with a higher diameter for this purpose than those farther away from the insert. As a consequence, the strength can increase smoothly in the direction of the inserts, instead of exhibiting a spasmodic behavior. The inserts can be fabricated in one and the same additive manufacturing process, i.e., via 3D printing, and thus be directly connected with the network of the core layer.

In another embodiment of the invention, a network-like arrangement of rods is interrupted in at least one row.

The pins and rods together form a network. Looking from a top layer in the viewing direction of the opposing top layer, the rods form a network-like arrangement. For example, this can form a pattern of rectangles or triangles. If less of a load is expected at one location of the network of rods in the direction of the rods than elsewhere in the component, for example, this row can be economized under some circumstances, which helps minimize the weight of the component. In terms of the preferred manufacturing process, 3D printing, this row can simply remain cut out, without having to remove a row of a mass-produced structure after the fact.

In another embodiment of the invention, the distances between the pins in the first group of pins differ from the distances between the pins in the second group of pins.

Various distances between the pins enable different strengths, but also at the expense of varying weights. The packing density of pins makes it possible to achieve the desired stiffness and stability of the panel to reflect the load in question.

In another embodiment of the invention, the diameter of a first group of rods differs from that of a second group of rods.

The variation of pin diameters can be applied analogously to the diameter of the rods. In areas of the panel exposed to higher loads, the stiffness and strength of the core layer can be elevated by fabricating the rods with higher diameters.

In another embodiment of the invention, the diameter of the pins and diameter of the rods measures between 0.3 and 1.0 mm

This diameter depends first and foremost on the shape of the network comprised of rods and pins, although the used printing process can impose restrictions. For example, a minimal diameter may result from a restricted buckling resistance of the pins.

Another aspect of the invention indicates a method for manufacturing a sandwich panel for an aircraft, in which a network comprised of pins and the rods interconnecting the pins is first fabricated in an additive manufacturing process. The network is thereafter arranged between an upper and lower top layer.

In this process, the pins and rods are fabricated via additive manufacturing. The overall component is here generated by repeatedly applying layers of plastic. Highly complex structures arise due to the shared structure comprised of rods and pins, under some circumstances of rods and pins with variable diameters, or to the irregular positions of the rods and pins. For example, these are virtually generated on a computer, and then relayed to the device for additive manufacturing, i.e., a 3D printer. The latter applies the material, e.g., plastic, in layers. The layers are applied one on top of the other until such time as the component has been completed in the uppermost plane. If the curing process has advanced to a sufficient extent, the resultant network of pins and rods is arranged between the upper and lower top layer. For example, this network can be attached to the top layers through adhesive bonding.

In another embodiment of the invention, honeycombs are also fabricated via the additive manufacturing process while making the network comprised of pins and rods interconnecting the pins, wherein the pins, the rods and the honeycombs consist of a continuous material.

In this embodiment, the fabrication of honeycombs is incorporated into the printing process. In other words, the 3D printer manufactures the pins, the rods and the honeycombs in a single printing process. As a consequence, the network of the core layer can be fabricated in one process, so that the result of the printing process is a single network of coherent elements comprised of pins, rods and honeycombs, for example. For example, the rods adjoin the honeycombs in a continuous material flow.

However, it can also be provided that a previously fabricated network of rods and pins be inserted into the honeycombs, and that the honeycombs stem from another manufacturing process.

Another aspect of the invention indicates an aircraft with a sandwich panel described above and in the following.

Exemplary embodiments of the invention are described below drawing reference to the figures. In the latter, the identical reference numbers denote the same or similar elements. However, the same or similar elements can also be denoted by different reference numbers.

### BRIEF DESCRIPTION OF THE FIGURES

FIG. 1 shows a side view of a sandwich panel according to an exemplary embodiment of the invention.

FIG. 2 shows a uniformly distributed arrangement of pins and rods in a sandwich panel according to another exemplary embodiment of the invention.

FIG. 3 shows a non-uniformly distributed arrangement of pins and rods in a sandwich panel according to another exemplary embodiment of the invention.

FIG. 4 shows an insert in the sandwich panel according to another exemplary embodiment of the invention.

FIG. 5 shows an insert with star-shaped rods in the sandwich panel according to another exemplary embodiment of the invention.

FIG. 6 shows a sandwich panel with honeycombs according to another exemplary embodiment of the invention.

FIG. 7 shows a spatial view of the sandwich panel according to another exemplary embodiment of the invention.

FIG. 8 shows a spatial view of the sandwich panel with asymmetrically arranged rods according to another exemplary embodiment of the invention.

FIG. 9 shows the arrangement of pins and rods around an insert in the sandwich panel according to another exemplary embodiment of the invention.

FIGS. 10a and 10b show various pin thicknesses around an insert in the sandwich panel according to another exemplary embodiment of the invention.

FIG. 11 shows a locally variable arrangement of rows of rods in a sandwich panel according to another exemplary embodiment of the invention.

FIG. 12 shows pins, rods and top layers in the sandwich panel according to another exemplary embodiment of the invention.

FIG. 13 shows honeycombs in the sandwich panel according to another exemplary embodiment of the invention.

FIGS. 14a and 14b show pins and rods embedded in honeycombs in the sandwich panel according to another exemplary embodiment of the invention.

FIG. 15 shows an outline of a sandwich panel with pins, rods, honeycombs and top layers according to another exemplary embodiment of the invention.

FIG. 16 shows the steps in a method for manufacturing a sandwich panel according to another exemplary embodiment of the invention.

### DETAILED DESCRIPTION OF EXEMPLARY EMBODIMENTS

The illustrations on the figures are schematic and not to scale.

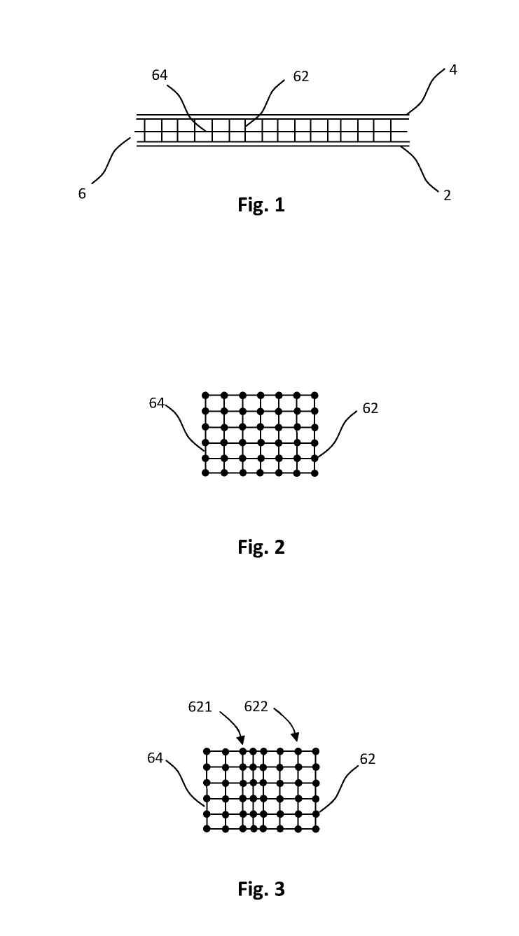

FIG. 1 shows a side view of a sandwich panel for an aircraft with the pins 62, the rods 64, which are both contained in a core layer 6, as well as an upper top layer 4 and a lower top layer 2. For example, the latter can be designed as a floor panel. In this example, the rods 64 form a plane parallel to the top layers 2, 4, and are centrally arranged on the pins 62, i.e., in an imaginary central plane between the upper top layer 4 and lower top layer 2.

FIG. 2 shows a top view of an arrangement of pins 62 and rods 64. The arrangement is selected in such a way that pins 62 and rods 64 form a uniformly distributed grid. In other words, the pins 62 are arranged equidistantly, i.e., uniformly and at a constant distance, relative to each other, and that the rods form a network, so that the network appears to consist of rectangles.

FIG. 3 shows a top view of a non-uniform arrangement of pins 62, so that a first group 621 of pins exhibits a narrower distance between the pin rows in one direction than a second group 622 of pins. This case takes stock of a special load case, in which the core layer 6 must withstand a higher compressive force in the area of the first group 621 of pins than in an area of the second group 622 of pins.

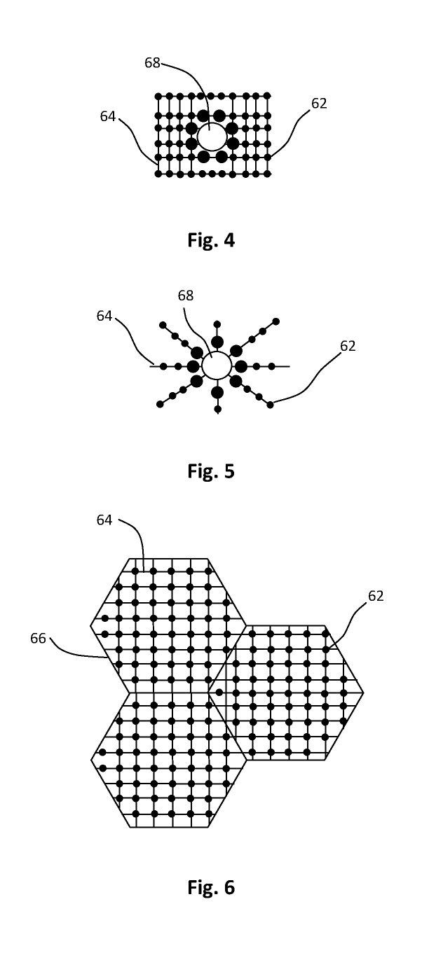

FIG. 4 shows a top view of a non-uniform arrangement of pins 62 and rods 64, wherein the pins 62 are additionally given a larger diameter in proximity to the area around the insert 68. Furthermore, the pins 62 are arranged in a rectangular pattern in this exemplary embodiment.

FIG. 5 again shows an insert 68 with a special arrangement of pins 62 and accompanying rods 64. In this exemplary embodiment, the diameters of the pins 62 are larger in the direction of the insert 68, and the rods 64 form a star-shaped arrangement around the insert 68, so that the pins 62 are interconnected by the rods 64 in the shape of a star away from the insert. This increases the density of pins in proximity to the insert.

FIG. 6 shows a top view of a uniform arrangement of pins 62 and rods 64, wherein hexagonal honeycombs 66 are provided in addition to the pins. Each honeycomb 66 forms a space inside of its lateral walls, in which there is a plurality of pins and rods. The honeycombs 66, pins 62 and rods 64 can be fabricated in a single production process with a 3D printer.

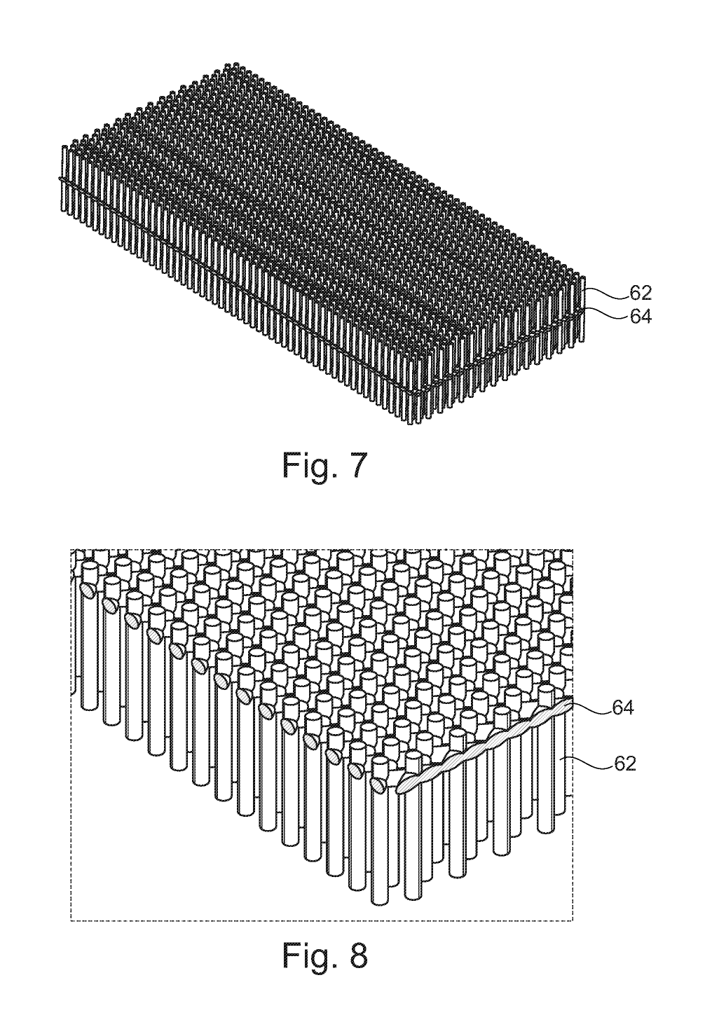

FIG. 7 shows a spatial view of the network of pins 62 and rods 64. In this exemplary embodiment, the rods 64 are situated in the middle of the pins 62, i.e., at the height of half the length of the pins 62. The rows of pins 62 are offset relative to each other by the length of half the pin distance. If a respective pin were to be connected by straight lines with all of its adjacent pins, the connecting lines would reveal recurring triangles. In other words, straight lines are drawn that connect as many pins as possible, so that pairs of lines can be found that exhibit an angle unequal to 90° relative to each other.

FIG. 8 shows a variation of the network structure from FIG. 7. As opposed to FIG. 7, the rods 64 are not situated at half the height of the pins 62, but spaced significantly apart from the imaginary central plane between the top layers 2, 4. In other words, the rods are much closer to one top layer than to the other.

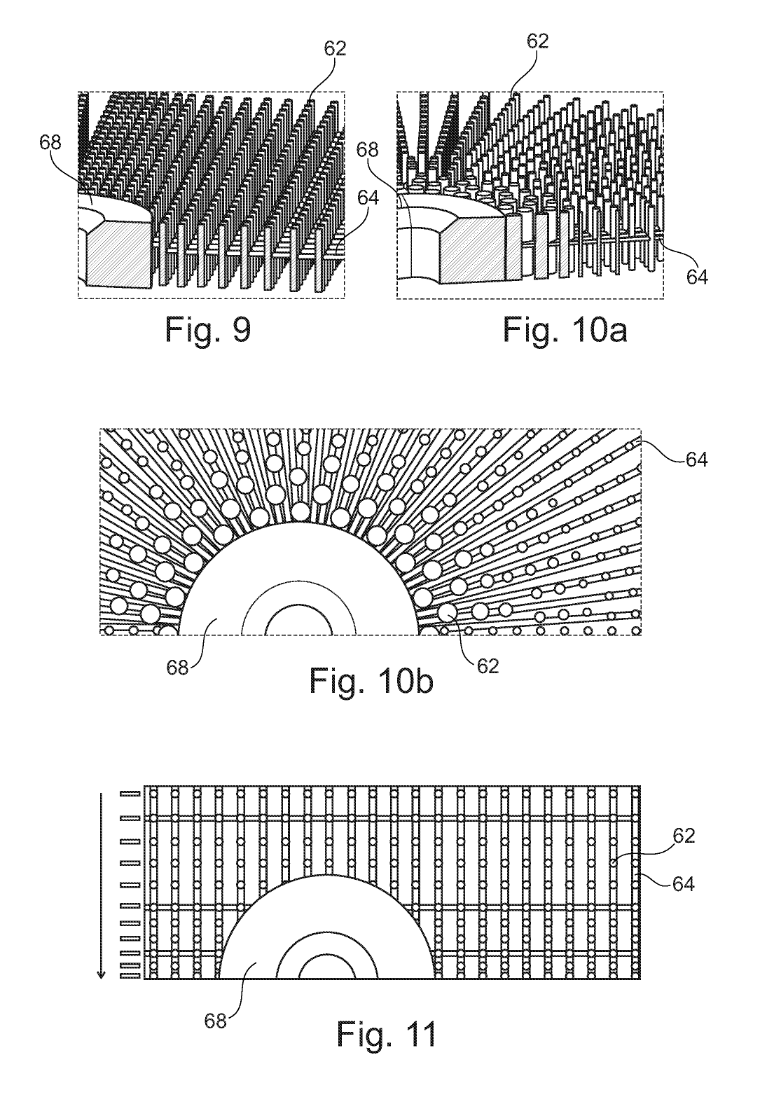

FIG. 9 shows an arrangement of pins 62 around an insert 68. The pins 62 are here arranged in rows, which narrow in a direction toward the insert 68. Therefore, the non-uniformity of the arrangement of pins 62 is limited to precisely one direction, in which the packing density of the rows of pins 62 increases. The rods 64 are again situated in the middle of the height of the pins 62.

FIGS. 10a and 10b show a star-like arrangement of pins 62 around an insert 68, wherein the thickness of the pins 62 here additionally increases in the direction toward the insert 68. FIG. 10a shows a spatial view, and FIG. 10b a top view of the structure comprised of pins 62, rods 64 and an insert 68. In addition to its function to strengthen the shear strength of the panel, for example, the insert 68 also causes a weakening in a direction perpendicular to the top layers 2, 4, for example. In order to offset this weakening, the pins 62 are thicker in design toward the insert 68, which can again balance out the weakening.

FIG. 11 shows a top view of the structure comprised of pins 62, rods 64 and an insert 68. This exemplary embodiment depicts a special arrangement of pins 62 and rods 64 around an insert 68. The pins 62 are arranged in rows, wherein the packing density of the rows increases in precisely one direction toward the insert 68. In the other direction, the packing density of the rows remains constant over this direction. In addition to the variability in the packing density of the rows of pins 62, the frequency of rods 64 is here varied. Rods 64 are here arranged in rows in precisely one direction, wherein these rows are non-uniformly distributed over a direction perpendicular to the rows in the plane of the arising grid. The density of the rows varies. As a consequence, there inevitably exist pins 62, which are connected with other pins 62 by rods 64 in only one direction.

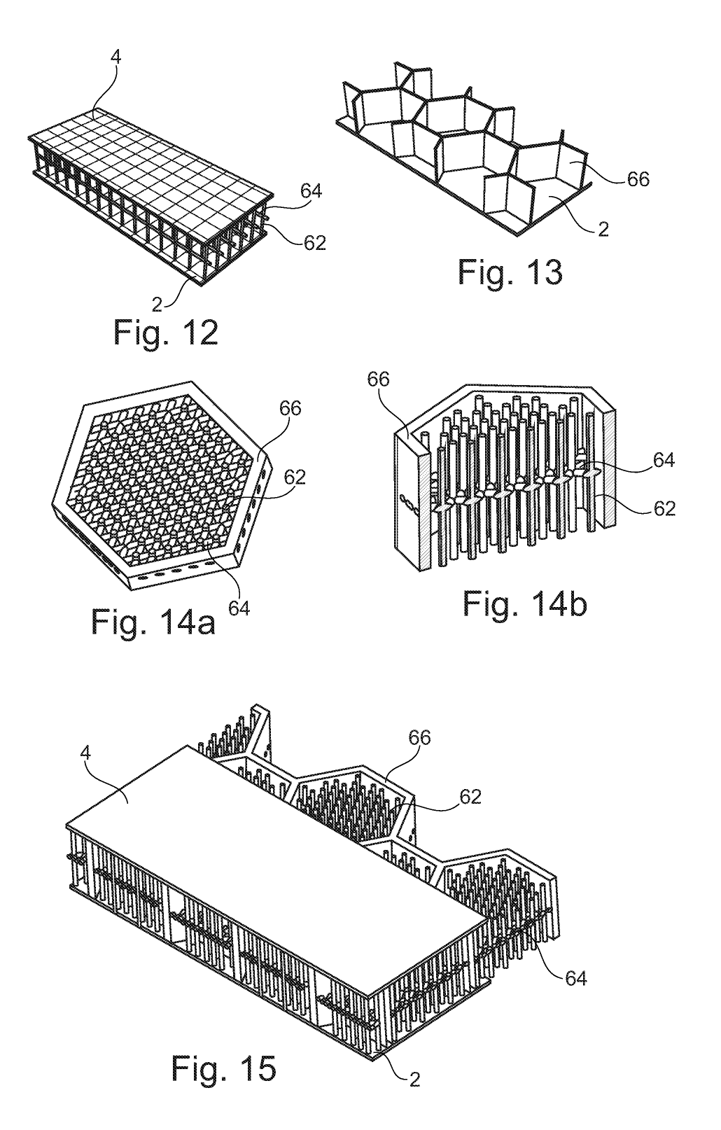

FIG. 12 shows a sandwich panel for an airplane with a lower top layer 2, an upper top layer 4, pins 62 and rods 64. The top layers 2, 4 consist of carbon fiber-reinforced plastic, and the pins 62 and rods 64 consist of polyether ether ketone. The top layers 2, 4 are attached by means of resin to the one-piece network of pins 62 and rods 64.

FIG. 13 shows honeycombs 66, which are specially fabricated for the one-piece structure of pins 62 and rods 64, wherein this one-piece structure is fitted into the respective otherwise fabricated honeycombs 66, and then adhesively bonded. Also shown is the lower top layer 2, to which the honeycombs 66 are adhesively bonded.

FIGS. 14a and 14b show the alternative to the exemplary embodiment on FIG. 13 with honeycombs. In FIGS. 14a and 14b, the pins 62, rods 64 and honeycombs 66 are fabricated out of precisely one piece, i.e., the honeycombs are fabricated in the same printing process along with the pins 62 and rods 64. A 3D printer applies thin layers of plastic or the respective material one at a time, wherein the layers are simultaneously applied in one printing process for the pins 62, rods 64 and lateral walls of the honeycombs 66. For example, the diameter of a hexagonal honeycomb measures 15 mm FIG. 14a and FIG. 14b show the aforesaid structure in different spatial views.

FIG. 15 shows a spatial view of a lower top layer 2, an upper top layer 4 and a core layer 6, which exhibits the pins 62, rods 64 and honeycombs 66. The elements of the core layer 6 are fabricated as a one-piece component in a 3D printer. In other words, pins 62, rods 64 and honeycombs 66 are fabricated simultaneously out of a continuous material with a 3D printer. The top layers 2, 4 are attached to the elements of the core layer 6 via adhesive bonding, for example. As a consequence, the respective ends of the pins 62 and upper edges of the honeycombs 66 are adhesively bonded with the top layers 2, 4. The rods 64 remain inside the core layer 6 without contacting the top layers 2, 4, and seamlessly adjoin the honeycombs, since both are fabricated out of the same material in the same printing process.

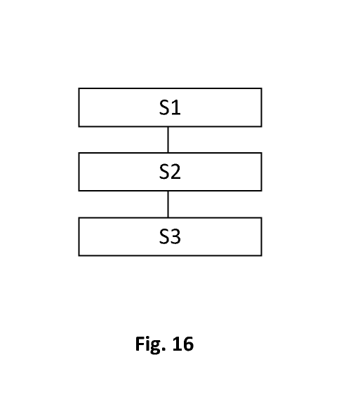

FIG. 16 shows a method for manufacturing a floor panel for an aircraft. In step S1, a network of pins 62 and rods 64 interconnecting the pins 62 is fabricated in an additive manufacturing process. In step S2, the network is situated between an upper top layer and a lower top layer. In step S3, the panel is incorporated into a passenger cabin or cargo hold of an aircraft.

In addition, let it be noted that “encompassing” and “exhibiting” do not preclude any other elements or steps, and that “an” or “a” do not rule out a plurality. Let it further be noted that features or steps described with reference to one of the above exemplary embodiments can also be used in combination with other features or steps of other exemplary embodiments described above. Reference numbers in the claims are not to be construed as limitations.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or one do not exclude a plural number, and the term or means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### REFERENCE LIST

2 Lower top layer
4 Upper top layer
6 Core layer
62 Pins
621 First group of pins
622 Second group of pins
64 Rods
66 Honeycombs
68 Insert

1. A sandwich panel for an aircraft, the sandwich panel comprising:
a lower top layer;
an upper top layer; and
a core layer,
wherein the core layer includes a plurality of pins,
wherein the plurality of pins extends from the lower top layer in the direction of the upper top layer,
wherein the pins are interconnected by a plurality of rods,
wherein the plurality of rods run inside the core layer, and
wherein the pins and rods form a one-piece network.

2. The sandwich panel of claim 1,
wherein the sandwich panel is a floor panel.

3. The sandwich panel of claim 1,
wherein the pins and rods are fabricated in an additive manufacturing process.

4. The sandwich panel of claim 1,
wherein the rods adjoin the pins at a right angle in the middle of the longitudinal direction of the pins.

5. The sandwich panel of claim 1,
wherein the core layer further includes a plurality of honeycombs, and
wherein the plurality of honeycombs is arranged in such a way that a first opening of one of the plurality of honeycombs extends to the lower top layer, and a second opening of the one of the plurality of the honeycombs extends to the upper top layer, and the lateral walls of the honeycombs extend at a right angle to the lower top layer and to the upper top layer.

6. The sandwich panel of claim 5,
wherein a group of the pluralities of pins and rods is situated in the space spanned by one of the plurality of the honeycombs, and
wherein the honeycombs, the pins and the rods are made out of a continuous material, so that the rods in conjunction with the pins and the honeycombs are configured as a single piece.

7. The sandwich panel of claim 1,
wherein a first group of the plurality of pins has a different diameter than a second group of the plurality of pins.

8. The sandwich panel of claim 7,
wherein the core layer further includes an insert, and
wherein a diameter of the pins increases toward the insert.

9. The sandwich panel of claim 1,
wherein a network-like arrangement of rods is interrupted in at least one row.

10. The sandwich panel of claim 7,
wherein distances between the pins in the first group of pins differ from distances between the pins in the second group of pins.

11. The sandwich panel of claim 7,
wherein a first group of the plurality of rods has a different diameter than a second group of the plurality of rods.

12. The sandwich panel of claim 1,
wherein a diameter of the pins and a diameter of the rods measures between 0.3 and 1.0 mm.

13. A method for manufacturing a sandwich panel for an aircraft, the method comprising:
fabricating a network of pins and rods interconnecting the pins in an additive manufacturing process;
situating the network between an upper top layer and a lower top layer; and
incorporating the sandwich panel in a passenger cabin or cargo hold of an aircraft.

14. The method of claim 13,
wherein honeycombs are also produced while fabricating the network of pins and rods interconnecting the pins in an additive manufacturing process, and
wherein the pins, the rods and the honeycombs include a continuous material.

15. An aircraft with a sandwich panel comprising:
a lower top layer;
an upper top layer; and
a core layer,
wherein the core layer includes a plurality of pins,
wherein the plurality of pins extends from the lower top layer in the direction of the upper top layer,
wherein the pins are interconnected by a plurality of rods,
wherein the plurality of rods run inside the core layer, and
wherein the pins and rods form a one-piece network.
